(19) United States
(12) Patent Application Publication
(10) Pub. No.: US 2018/0081690 A1
(43) Pub. Date: Mar. 22, 2018

(54) PERFORMING DISTRIBUTED BRANCH PREDICTION USING FUSED PROCESSOR CORES IN PROCESSOR-BASED SYSTEMS

(71) Applicant: QUALCOMM Incorporated, San Diego, CA (US)

(72) Inventors: Anil Krishna, Cary, NC (US); Vignyan Reddy Kothinti Naresh, Morrisville, NC (US); Gregory Michael Wright, Chapel Hill, NC (US)

(21) Appl. No.: 15/271,403

(22) Filed: Sep. 21, 2016

(51) Int. Cl. G06F 9/38

(52) U.S. Cl. CPC G06F 9/3806; G06F 12/0851

(57) ABSTRACT

Performing distributed branch prediction using fused processor cores in processor-based systems is disclosed. In one aspect, a distributed branch predictor is provided as a plurality of processor cores supporting core fusion. Each processor core is configured to receive a program identifier from another of the processor cores (or from itself), generate a subsequent predicted program identifier, and forward the predicted program identifier (and, optionally, a global history indicator) to the appropriate processor core responsible for handling the next prediction. The processor core also fetches a header and/or one or more instructions for the received program identifier, and sends the header and/or the one or more instructions to the appropriate processor core for execution. The processor core also determines the processor core that will handle execution of the predicted program identifier, and sends that information to the processor core that received the predicted program identifier as an instruction window tracker.

### BACKGROUND

### I. Field of the Disclosure

The technology of the disclosure relates generally to branch prediction, and, in particular, to branch prediction in processor-based systems capable of processor core fusion.

### II. Background

Some processor architectures are capable of “core fusion,” which is a feature that enables multiple individual processor cores to logically “fuse” and work together as a higher-performing single-threaded processor. Such fused cores may offer more arithmetic logic units (ALUs) and other execution resources to an executing program, while simultaneously enabling a larger instruction window (i.e., a set of instructions from an executing program that are visible to the processor). Core fusion may be especially beneficial when used by block-based processor architectures. However, to fully exploit the instruction-level parallelism enabled by the larger instruction window and the fused execution resources, the instruction window must be kept full with instructions on a correct control flow path of the program.

To address this challenge, a highly accurate branch predictor is desirable. Branch predictors are processor circuits or logic that attempt to predict an upcoming discontinuity in an instruction fetch stream, and, if necessary, to speculatively determine a target instruction block or instruction that is predicted to succeed the discontinuity. For instance, in a block-based architecture, a branch predictor may predict which instruction block will follow a currently executing instruction block, while a branch predictor in a conventional processor architecture may predict a target instruction to which a branch instruction may transfer program control. By employing a branch predictor, a processor may avoid the need to wait until a given instruction block or branch instruction has completed execution before fetching a subsequent instruction block or target instruction, respectively.

In a processor architecture supporting core fusion, each processor core may include its own branch predictor. To improve prediction accuracy when the processor cores are operating as a fused core, the resources available to each branch predictor may be increased (e.g., by providing larger predictor tables). However, oversizing each processor core's branch predictor resources may not be practical or practicable. Thus, it is desirable to provide per-core branch predictors that may be coalesced into a larger, logically unified, and more accurate distributed branch predictor for use when operating in a core fusion mode.

### SUMMARY OF THE DISCLOSURE

Aspects disclosed in the detailed description include performing distributed branch prediction using fused processor cores in processor-based systems. In this regard, in one aspect, a distributed branch predictor is provided as a plurality of processor cores that support core fusion. Each processor core is identical in terms of resources and configuration, and when acting as a fused processor core, each individual processor core operates in coordination with the other processor cores to provide distributed branch prediction. The individual branch predictors for the processor cores are address interleaved, such that each processor core is responsible for performing branch predictions and fetching headers and/or instructions for a subset of program identifiers (e.g., program counters (PCs) or addresses). Each processor core is configured to receive a program identifier (e.g., a PC of a predicted next instruction or instruction block) from another of the processor cores (or from itself). The processor core generates a subsequent predicted program identifier and forwards the predicted program identifier (and, optionally, a global history indicator) to the appropriate processor core that is responsible for handling the predicted program identifier and for using the predicted program identifier to make the next prediction. This results in a sequence of branch predictions that moves irregularly from processor core to processor core, referred to herein as a “predict-and-fetch wave.” The processor core also fetches a header and/or one or more instructions for the received program identifier, and sends the header and/or the one or more instructions to the appropriate processor core for execution. The sequence of execution proceeds in order from processor core to processor core, and is referred to herein as a “promote wave.” Finally, the processor core also determines which processor core will handle execution of the instructions for the predicted program identifier (e.g., based on a size indicated by the header and/or a size of the one or more instructions for the received program identifier). That information is then sent to the processor core that received the predicted program identifier as an instruction window tracker, so the instructions for the predicted program identifier can be sent to the correct processor core responsible for execution.

In some aspects disclosed herein, each processor core that is responsible for predicting a successor for a given program identifier is also assumed to be the processor responsible for fetching the one or more instructions associated with the given program identifier. In such aspects, an instruction cache from which instructions may be fetched is assumed to be interleaved across the processor cores in the same manner as prediction responsibilities are distributed, and therefore the processor core making a prediction may also start an instruction fetch as soon as the program identifier is received. Alternatively, some aspects may provide that the processor core that executes instructions is configured to also fetch instructions from whichever processor cores hold the instructions. The minimum information needed at the predicting processor core in such aspects includes information about the number of execution resources used by the current program identifier, which is sufficient to allow the processor core to compute where the predicted program identifier will execute. The predicting processor core may then inform the executing processor core to fetch and execute starting at the predicted program identifier.

In another aspect, a distributed branch predictor for a multi-core processor-based system is provided. The distributed branch predictor includes a plurality of processor cores configured to interoperate as a fused processor core. Each of the plurality of processor cores includes a branch predictor and a plurality of predict-and-fetch engines (PFEs). Each processor core of the plurality of processor cores is configured to receive, from a second processor core of the plurality of processor cores, a program identifier associated with an instruction block and corresponding to the processor core as a received program identifier. Each processor core is further configured to allocate a PFE of the plurality of PFEs for storing the received program identifier. Each processor core is also configured to predict, using the branch predictor, a subsequent program identifier as a predicted program identifier. Each processor core is additionally configured to identify, based on the predicted program identifier, a processor core of the plurality of processor cores corresponding to the predicted program identifier as a target processor core. Each processor core is further configured to store an identifier of the target processor core in the PFE. Each processor core is also configured to send the predicted program identifier to the target processor core. Each processor core is additionally configured to initiate a fetch of one of a header for the instruction block and one or more instructions of the instruction block based on the received program identifier.

In another aspect, a distributed branch predictor is provided. The distributed branch predictor includes a means for receiving, by a processor core of a plurality of processor cores, from a second processor core of the plurality of processor cores, a program identifier associated with an instruction block and corresponding to the processor core as a received program identifier. The distributed branch predictor further includes a means for allocating a PFE of a plurality of PFEs for storing the received program identifier. The distributed branch predictor also includes a means for predicting, using a branch predictor of the processor core, a subsequent program identifier as a predicted program identifier. The distributed branch predictor additionally includes a means for identifying, based on the predicted program identifier, a processor core of the plurality of processor cores corresponding to the predicted program identifier as a target processor core. The distributed branch predictor further includes a means for storing an identifier of the target processor core in the PFE. The distributed branch predictor also includes a means for sending the predicted program identifier to the target processor core. The distributed branch predictor additionally includes a means for initiating a fetch of one of a header for the instruction block and one or more instructions of the instruction block based on the received program identifier.

In another aspect, a method for performing distributed branch prediction is provided. The method includes receiving, by a processor core of a plurality of processor cores, from a second processor core of the plurality of processor cores, a program identifier associated with an instruction block and corresponding to the processor core as a received program identifier. The method further includes allocating a PFE, of a plurality of PFEs for storing the received program identifier. The method also includes predicting, using a branch predictor of the processor core, a subsequent program identifier as a predicted program identifier. The method additionally includes identifying, based on the predicted program identifier, a processor core of the plurality of processor cores corresponding to the predicted program identifier as a target processor core. The method further includes storing an identifier of the target processor core in the PFE. The method also includes sending the predicted program identifier to the target processor core. The method additionally includes initiating a fetch of one of a header for the instruction block and one or more instructions of the instruction block based on the received program identifier.

### BRIEF DESCRIPTION OF THE FIGURES

FIG. 1 is a block diagram of an exemplary processor-based system that provides multiple processor cores configured to operate as a fused processor core;

FIG. 2 is a block diagram illustrating exemplary elements of a processor core of the processor-based system of FIG. 1 for performing distributed branch prediction;

FIG. 3 is a diagram illustrating exemplary communications flows among the multiple processor cores of FIGS. 1 and 2 for propagating a predict-and-fetch wave among the processor cores for predicting program control flow;

FIG. 4 is a diagram illustrating exemplary communications flows among the multiple processor cores of FIGS. 1 and 2 for propagating a promote wave among the processor cores for retrieving fetched data and forwarding the fetched data to processor cores for execution;

FIGS. 5A and 5B are flowcharts illustrating exemplary operations of a processor core of the multiple processor cores of FIGS. 1 and 2 for propagating a predict-and-fetch wave;

FIGS. 6A and 6B are flowcharts illustrating exemplary operations of a processor core of the multiple processor cores of FIGS. 1 and 2 for propagating a promote wave;

FIG. 7 is a flowchart illustrating exemplary operations of a processor core of the multiple processor cores of FIGS. 1 and 2 for receiving and storing fetched data;

FIG. 8 is a flowchart illustrating exemplary operations of a processor core of the multiple processor cores of FIGS. 1 and 2 for detecting and handling a branch misprediction;

FIG. 9 is a flowchart illustrating exemplary operations of a processor core of the multiple processor cores of FIGS. 1 and 2 for receiving and handling a flush signal; and

FIG. 10 is a block diagram of an exemplary processor-based system that can include the multiple processor cores of FIGS. 1 and 2.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

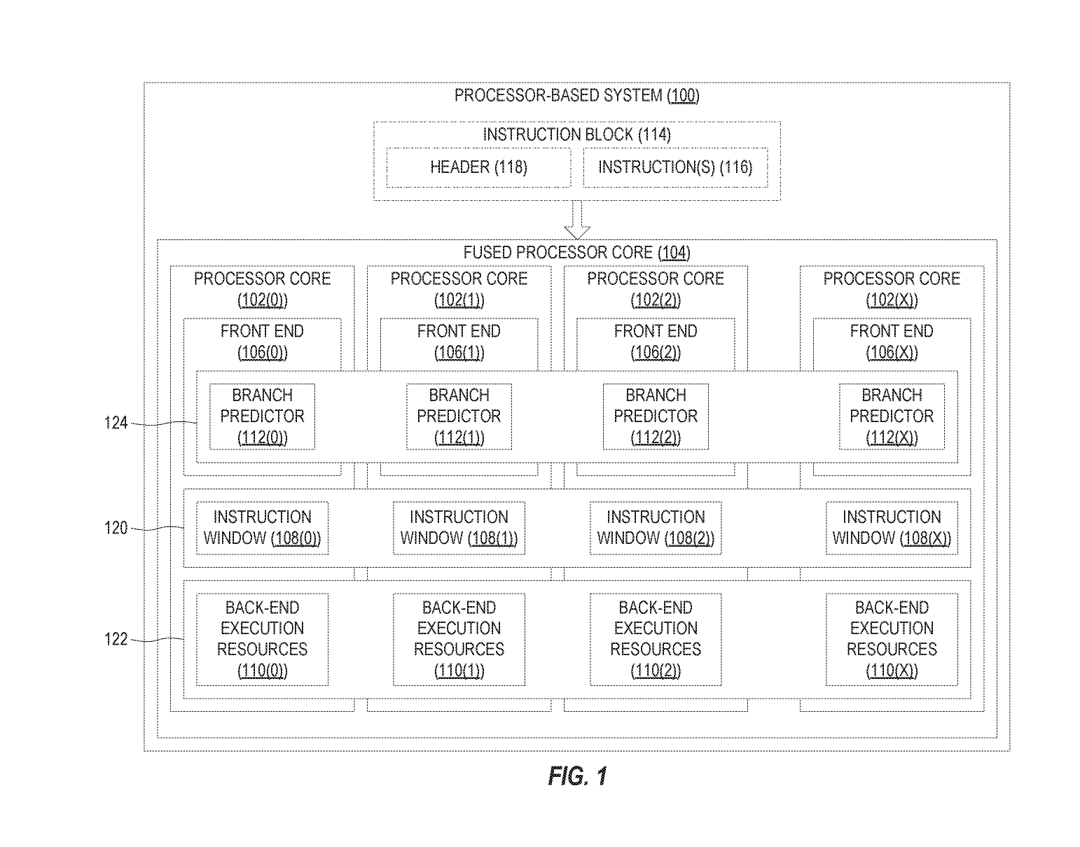

Aspects disclosed in the detailed description include performing distributed branch prediction using fused processor cores in processor-based systems. As described herein, individual processor cores are configured to receive previously predicted program identifiers, predict next program identifiers, and fetch and forward data for execution to appropriate processor cores. In this regard, FIG. 1 illustrates an exemplary processor-based system 100 that provides a plurality of processor cores 102(0)-102(X) that may be configured to operate as a single fused processor core 104. In some aspects, the processor-based system 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that the processor-based system 100 may include additional elements not illustrated herein for the sake of clarity.

As seen in FIG. 1, each of the processor cores 102(0)-102(X) includes a corresponding front end 106(0)-106(X), an instruction window 108(0)-108(X), and back-end execution resources 110(0)-110(X). The front ends 106(0)-106(X) include resources for fetching and dispatching instruction blocks or instructions, and provide respective branch predictors 112(0)-112(X). The instruction windows 108(0)-108(X) of the processor cores 102(0)-102(X) represent instructions that are currently visible to the processor cores 102(0)-102(X). The back-end execution resources 110(0)-110(X) of the processor cores 102(0)-102(X) may include arithmetic logic units (ALUs) and/or other execution units.

Depending on the underlying architecture of the processor-based system 100, the fused processor core 104 may be configured to operate on instruction blocks (e.g., a block-based architecture) or on individual instructions (in the case of a conventional architecture). Thus, in a block-based architecture, the fused processor core 104 may process an instruction block 114 that includes one or more sequential instructions 116 that may be fetched and executed without any control flow sensitivity. The instruction block 114 may further include a header 118 containing metadata indicating, for example, how many instructions 116 exist within the instruction block 114. Branch prediction in the block-based architecture is needed only at boundaries between instruction blocks, and attempts to predict a following instruction block. In contrast, in a conventional architecture, the fused processor core 104 may fetch an instruction 116, and may perform branch prediction at each branch instruction encountered. It is to be understood that, while examples described herein may refer to block-based architectures, the methods and apparatus described herein may be applied to conventional architectures as well, and vice versa.

When operating as the fused processor core 104, many individual elements of the processor cores 102(0)-102(X) may be logically joined to act as a single element. For example, the instruction windows 108(0)108(X) may be treated as a single fused instruction window 120, and the back-end execution resources 110(0)-110(X) may be pooled into a set of unified fused back-end execution resources 122 when the processor cores 102(0)-102(X) are operating as the fused processor core 104. Similarly, the branch predictors 112(0)-112(X) distributed across the processor cores 102(0)-102(X) may be fused to operate as a single distributed branch predictor 124. The distributed branch predictor 124 may be capable of holding more state, which enables it to store more memory of past predictions and results, and improve future predictions. When operating as the distributed branch predictor 124, branch prediction resources (of the branch predictors 112(0)-112(X) may be address interleaved, such that an address of a branch instruction or instruction block for which a prediction is needed may be handled by a particular branch predictor 112(0)-112(X) associated with that address. For example, a branch predictor 112(0)-112(X) may be selected by performing a modulus operation on the address and the number X of branch predictors 112(0)-112(X).

In performing branch prediction, the branch predictors 112(0)-112(X) must continue making predictions into the future in order to fill the fused instruction window 120, without waiting for the execution and resolution of previously predicted branches. Each prediction by the branch predictors 112(0)-112(X) thus feeds the next prediction, which in turn feeds the next, and so on in a similar manner. Due to the address interleaving of the branch predictors 112(0)-112(X) discussed above, the processor core 102(0)-102(X) that services a current address will be responsible for predicting the next address. Because the branch predictions are based on program control flow, the order in which this sequence of branch predictions, referred to herein as the “predict-and-fetch wave,” moves among the processor cores 102(0)-102(X) may be irregular. This is in contrast to the “promote wave,” or the sequence in which the processor cores 102(0)-102(X) fetch and execute instructions 116 or instruction blocks 114. Each of the processor cores 102(0)-102(X) is employed to fetch and execute instructions 116 or instruction blocks 114 until its resources are exhausted, at which point the next processor core 102(0)-102(X) is used. The promote wave thus proceeds sequentially through the processor cores 102(0)-102(X), which simplifies recovery of a state of the fused processor core 104 should an exception, interrupt, or misprediction be encountered.

Thus, managing distributed branch prediction using the branch predictors 112(0)-112(X) may pose a number of challenges. A first challenge is management of and communications between the predict-and-fetch wave and the promote wave. In particular, the processor cores 102(0)-102(X) should allow the predict-and-fetch wave to jump among the processor cores 102(0)-102(X) while the position of the promote wave is tracked, so that predicted addresses may be forwarded to correct processor cores 102(0)-102(X) for fetching and execution of the associated instructions 116 or instruction blocks 114. Another challenge arises due to the fact that the predict-and-fetch wave can propagate independently of the promote wave. The predict-and-fetch wave may predict further in a future instruction stream than can be handled by the promote wave. The processor cores 102(0)-102(X) thus should be able to determine when the promote wave has stalled (e.g., due to lack of execution resources or excessive instruction fetch or execution time), and stall the predict-and-fetch wave accordingly. Finally, a mechanism should be provided to enable the promote wave to handle mispredictions by the predict-and-fetch wave. This may include stopping the current predict-and-fetch wave, starting a new, correct predict-and-fetch wave, and removing all state that is associated with the promote wave and that is younger than the misprediction.

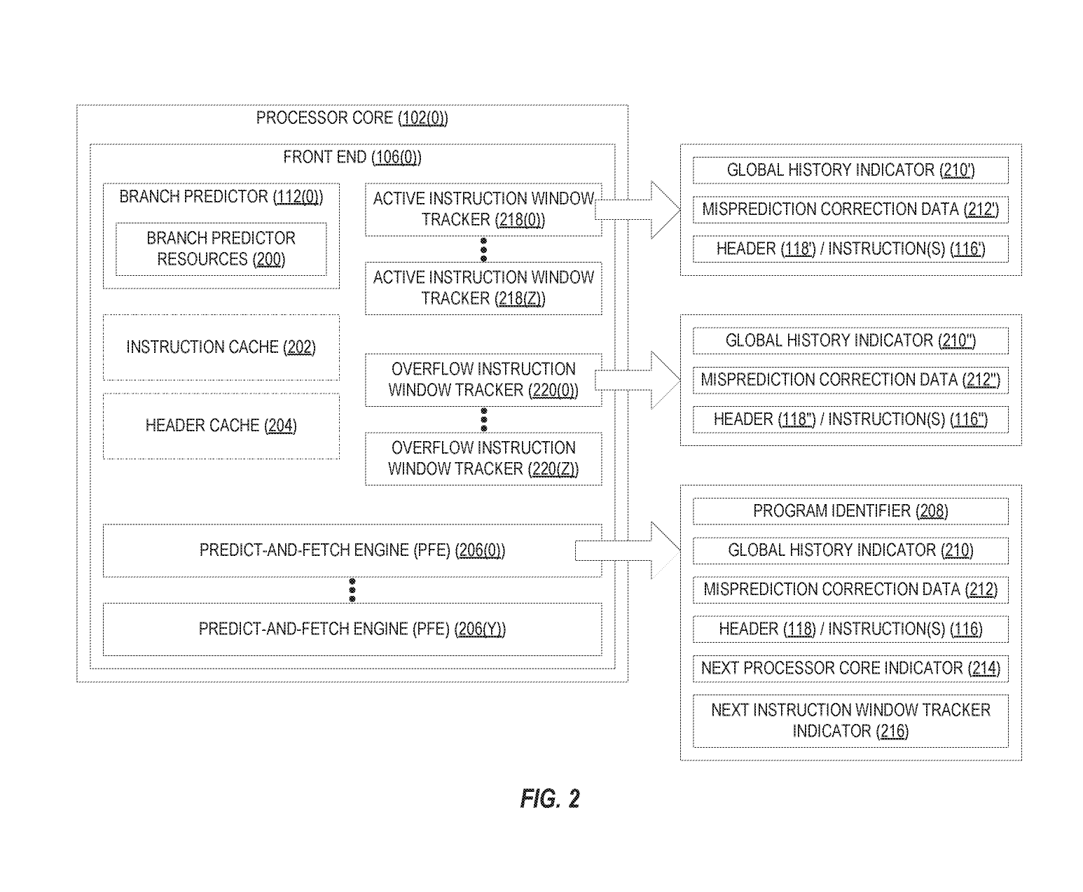

In this regard, FIG. 2 illustrates exemplary elements of one of the processor cores 102(0)-102(X) (in this example, the processor core 102(0)) of the processor-based system 100 of FIG. 1 for performing distributed branch prediction. Although only the processor core 102(0) is shown in FIG. 2, it is to be understood that the processor cores 102(0)-102(X) are all identical with respect to the elements described herein.

The branch predictor 112(0) of the processor core 102(0) provides branch predictor resources 200, which may include predictor tables and other structures and data for enabling branch prediction. The processor core 102(0) in some aspects may include an instruction cache 202 and a header cache 204. The header cache 204 may be used to cache metadata from an instruction block header such as the header 118 of FIG. 1. Similarly, the instruction cache 202 may cache the actual instructions of an instruction block, such as the one or more instructions 116 of FIG. 1. In some aspects, the processor core 102(0) may provide the instruction cache 202 and the header cache 204 as a unified instruction/header cache. The instruction cache 202 and the header cache 204 may be address interleaved, such that the address of an instruction block or an instruction may determine which of the processor cores 102(0)-102(X) will cache the header 118 or the one or more instructions 116.

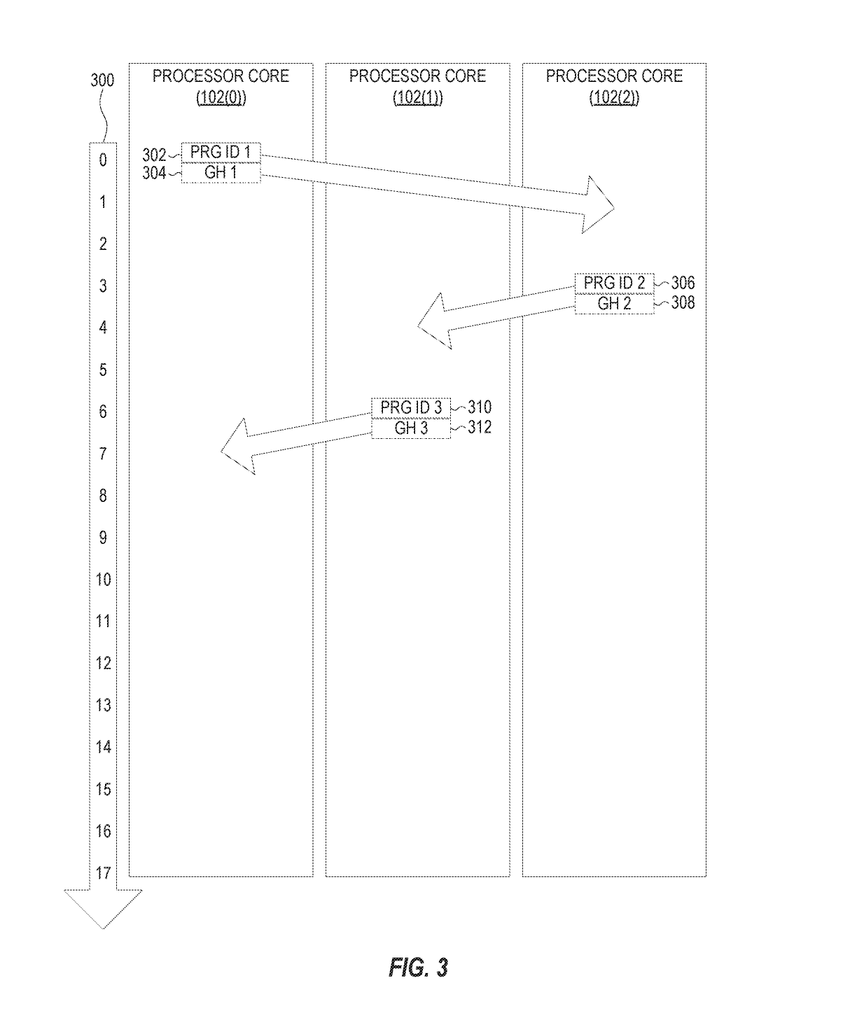

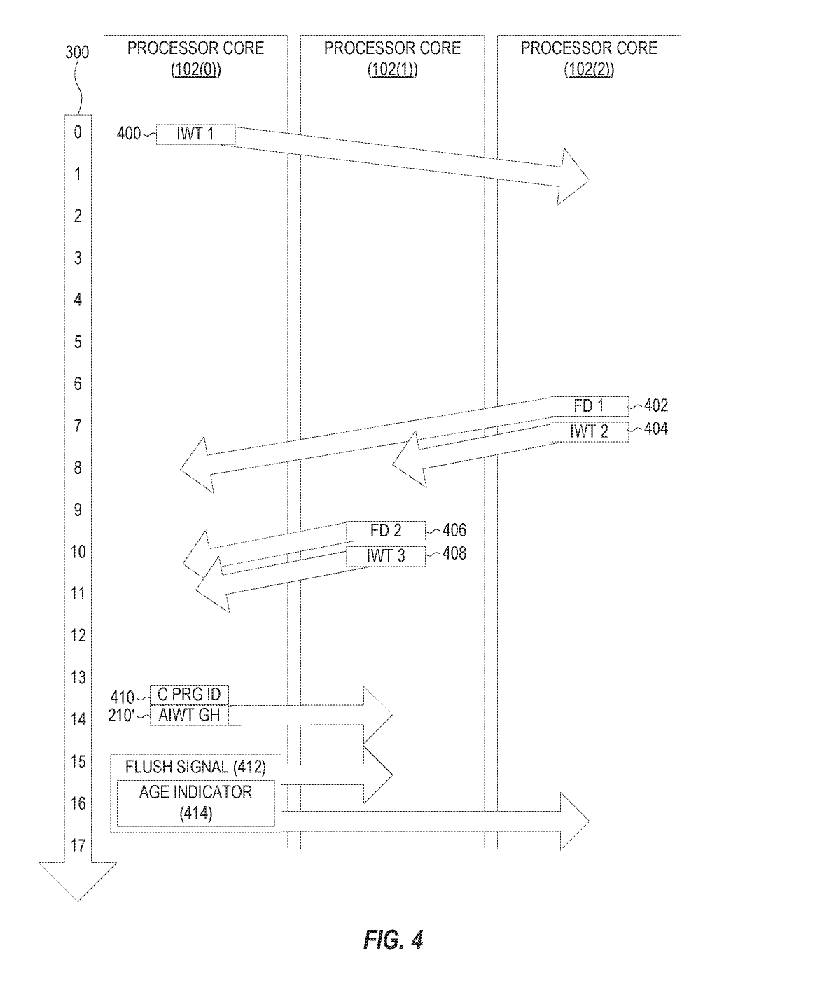

The processor core 102(0) also provides structures for managing the predict-and-fetch wave and the promote wave occurring during distributed branch prediction. In particular, the processor core 102(0) provides predict-and-fetch engines (PFEs) 206(0)-206(Y), active instruction window trackers 218(0)-218(Z), and overflow instruction window trackers 220(0)-220(Z). The contents of each of these structures is described in turn below, while the functionality of each structure in managing distributed branch prediction is discussed in greater detail below with respect to FIGS. 3 and 4.

The PFEs 206(0)-206(Y) represent hardware resources of the processor core 102(0) for holding state associated with the predict-and-fetch wave, and are allocated sequentially by the processor core 102(0) for each branch prediction made. When no PFEs 206(0)-206(Y) remain for allocation, the processor core 102(0) delays propagation of the predict-and-fetch wave to the next processor core 102(0)-102(X). In this manner, the PFEs 206(0)-206(Y) may be used to regulate the predict-and-fetch wave by limiting how deep control flow speculation by the processor core 102(0) is allowed to go.

The state held by each PFE 206(0)-206(Y) includes data needed to correct the corresponding branch prediction should the branch prediction prove to be incorrect. As seen in FIG. 2, each of the PFEs 206(0)-206(Y) includes a program identifier 208, a global history indicator 210, misprediction correction data 212, a header 118 or one or more instructions 116, a next processor core indicator 214, and a next instruction window tracker indicator 216. The program identifier 208 stores the address (e.g., a program counter (PC)) or other identifier associated with the most recent predicted instruction block or instruction received by the processor core 102(0). The global history indicator 210 stores a recent history of instructions and/or branches leading up to the current state. In some aspects, the global history indicator 210 may include a hash of a specified number of past program identifiers, or a series of bits that correspond to a specified number of past branch instructions and that indicate whether the branch was taken or not taken. Because the history represented by the global history indicator 210 is global across all of the processor cores 102(0)-102(X), the global history indicator 210 is passed among the processor cores 102(0)-102(X).

The misprediction correction data 212 of each of the PFEs 206(0)-206(Y) tracks which of the branch predictor resources (such as the branch predictor resources 200) across the processor cores 102(0)-102(X) should be updated in the event of a misprediction. In some aspects, the misprediction correction data 212 specifies which predictor tables and/or which predictor table entries should be corrected to roll back a misprediction. Each PFE 206(0)-206(Y) also stores the header 118 or the one or more instructions 116 fetched for the program identifier 208, and the next processor core indicator 214 indicating one of the processor cores 102(0)-102(X) to which the next predicted program identifier will be sent. When the promote wave reaches the processor core 102(0), the next instruction window tracker indicator 216 is used to store data indicating which of the processor cores 102(0)-102(X) will execute the one or more instructions 116 fetched for the program identifier 208. Together with the header 118 or the one or more instructions 116, the next instruction window tracker indicator 216 is used to compute which execution resource of which of the processor cores 102(0)-102(X) will be used by the next predicted program identifier, and generate an instruction window tracker for the next predicted program identifier.

The active instruction window trackers 218(0)-218(Z) of the processor core 102(0) represent hardware resources for controlling the underlying execution and instruction fetch resources of the processor core 102(0). A global history indicator 210′, misprediction correction data 212′, and a header 118′ or one or more instructions 116′ stored therein are received by the processor core 102(0) when the processor core 102(0) is the next one of the processor cores 102(0)-102(X) available for execution, and are assigned to a next available sequential active instruction window tracker 218(0)-218(Z). The global history indicator 210′ effectively represents a snapshot of the global history at the time a program identifier being executed by processor core 102(0) was predicted. This global history indicator 210′ may be used by the processor core 102(0) to start a new predict-and-fetch wave in the event of misprediction.

The overflow instruction window trackers 220(0)-220(Z) of the processor core 102(0) mimic the active instruction window trackers 218(0)-218(Z), but are not associated with fetch or execute resources of the processor core 102(0). The overflow instruction window trackers 220(0)-220(Z) are used to hold state data when a predicted instruction block or instruction is assigned to the processor core 102(0), but the required number of active instruction window trackers 218(0)-218(Z) is not available. The processor core 102(0) is configured to delay propagation of the predict-and-fetch wave if the overflow instruction window trackers 220(0)-220(Z) are in use. In this manner, the overflow instruction window trackers 220(0)-220(Z) may be used to regulate the predict-and-fetch wave. Each of the overflow instruction window trackers 220(0)-220(Z) provides a global history indicator 210″, misprediction correction data 212″, and a header 118″ or one or more instructions 116″, all of which store the same data as the global history indicator 210′, the misprediction correction data 212′, and the header 118′ or the one or more instructions 116′ of the active instruction window trackers 218(0)-218(Z).

To illustrate exemplary communications flows among the processor cores 102(0)-102(X) of FIGS. 1 and 2 for propagating a predict-and-fetch wave among the processor cores 102(0)-102(X) for predicting program control flow, FIG. 3 is provided. FIG. 3 shows a time axis 300 representing a flow of time from point zero (0) to point 17, and also shows processor cores 102(0), 102(1), and 102(2), operating as a fused processor core. Operations of each of the processor cores 102(0)-102(2) as the predict-and-fetch wave propagates will now be described.

At the start, the processor core 102(0) begins with what is assumed to be a non-speculative program identifier (“PRG ID 1”) 302 (e.g., a PC of an instruction block or an instruction) from which execution should begin. For purposes of this example, the program identifier 302 corresponds to the processor core 102(2), based on the address interleaving discussed above, and thus the processor core 102(2) is the “target processor core” for the program identifier 302. Furthermore, the header 118 and the one or more instructions 116 corresponding to the program identifier 302 should be supplied to the processor core 102(0) for execution, so the processor core 102(0) is considered the “execution processor core” for the program identifier 302.

At time point zero (0), the processor core 102(0) sends the program identifier 302 to the target processor core 102(2). Along with the program identifier 302, the processor core 102(0) may also send any other state information necessary for the processor core 102(2) to make the next branch prediction. In this regard, in the example of FIG. 3, the processor core 102(0) sends a global history indicator (“GH 1”) 304, which will provide data regarding any recent branch predictions. In some aspects, a local history may be maintained and used in place of the global history indicator 304, or no history information may be used at all.

The processor core 102(2) is responsible for generating the next branch prediction following the program identifier 302, and extending the predict-and-fetch wave to the processor core 102(0)-102(2) that serves the predicted instruction block or instruction. Accordingly, the processor core 102(2) allocates an available PFE (such as the PFEs 206(0)-206(Y) of FIG. 2) to track the state of the predict-and-fetch wave as well as the state data needed to forward the header 118 or instructions 116 for the received program identifier 302 to the appropriate processor core 102(0)-102(2). The processor core 102(2) may also look up and store the misprediction correction data 212 in the allocated PFE 206(0)-206(Y) to facilitate recovery from a misprediction. The processor core 102(2) generates a predicted program identifier (“PRG ID 2”) 306 a short time after the program identifier 302 reaches the processor core 102(2). The processor core 102(2) may also append data to the received global history indicator 304 to generate an updated global history indicator (“GH 2”) 308. The processor core 102(2) next sends the predicted program identifier 306 and the global history indicator 308 to the processor core 102(1), which in this example is the target processor core 102(1) for the predicted program identifier 306. The processor core 102(2) then initiates a fetch of the header 118 or the one or more instructions 116 corresponding to the received program identifier 302.

The predict-and-fetch wave then continues to move among the processor cores 102(0)-102(2) in the same manner. After receiving the program identifier 306 and the global history indicator 308, the processor core 102(1) allocates an available PFE (such as the PFE 206(0) of the PFEs 206(0)-206(Y) of FIG. 2) for the state data needed to forward the header 118 or instructions 116 for the received program identifier 302 to the appropriate processor core 102(0)-102(2), and to store misprediction correction data 212. As seen in FIG. 3, the processor core 102(1) also generates a predicted program identifier (“PRG ID 3”) 310 a short time after the program identifier 306 reaches the processor core 102(1). In some aspects, the processor core 102(1) may also update the received global history indicator 308 to generate a global history indicator (“GH 3”) 312. The processor core 102(1) then sends the predicted program identifier 310 and the global history indicator 312 to the processor core 102(0), which in this example is the target processor core 102(0) for the predicted program identifier 310. The processor core 102(1) initiates a fetch of the header 118 or the one or more instructions 116 corresponding to the received program identifier 310.

The predict-and-fetch wave thus continues unabated until one of the following conditions is met: a last PFE 206(0)-206(Y) at one of the processor cores 102(0)-102(2) is allocated; one of the processor cores 102(0)-102(2) detects that an overflow instruction window tracker 220(0)-220(Z) is in use; or a flush signal is received. The first two (2) cases indicate that the predict-and-fetch wave is advancing too far ahead of the promote wave, and thus propagation of the predict-and-fetch wave will be paused until the initiating condition has lifted. In the last case, a flush recovery will be initiated, and the predict-and-fetch wave will be restarted.

FIG. 4 is a diagram illustrating exemplary communications flows among the processor cores 102(0)-102(X) of FIGS. 1 and 2 for propagating a promote wave among the processor cores 102(0)-102(X) for retrieving and forwarding fetched data to processor cores 102(0)-102(X) for execution. Like FIG. 3, FIG. 4 shows the processor cores 102(0), 102(1), and 102(2) operating as a fused processor core, and the same time axis 300 representing a flow of time from point zero (0) to point 17. Thus, it is to be understood that the communications flows shown in FIG. 4 occur in parallel with those of FIG. 3. Operations of each of the processor cores 102(0)-102(2) as the promote wave propagates will now be described.

In the example of FIG. 4, the processor core 102(0), in addition to and in parallel with sending the program identifier 302 and the global history indicator 304 as shown in FIG. 3, sends an instruction window tracker (“IWT 1”) 400 to the processor core 102(2). Recall that, although the processor core 102(2) is responsible for predicting the next program identifier 306 following the received program identifier 302, the processor core 102(2) is not the processor core on which the instructions or instruction block associated with the received program identifier 302 will execute. Thus, the instruction window tracker 400 includes data to inform the processor core 102(2) that the data fetched for the program identifier 302 by the processor core 102(2) should be sent to an active instruction window tracker 218(0)-218(Z) of the processor core 102(0) for execution by the processor core 102(0). Accordingly, after fetched data (“FD 1”) 402 for the program identifier 302 is retrieved by the processor core 102(2), the processor core 102(2) sends the fetched data 402 to the processor core 102(0). In some aspects, the processor core 102(2) may also send, in conjunction with the fetched data 402, the global history indicator 304 to the processor core 102(0).

The processor core 102(2) also calculates, based on the fetched data 402, the processor core 102(0)-102(2) to which the next batch of fetched data (i.e., the data fetched for the predicted program identifier 306 by the processor core 102(1)) should be sent. For example, the processor core 102(2) may determine based on a size of the fetched data 402 (e.g., if the fetched data 402 is one or more instructions) or a size indicated by the fetched data 402 (e.g., if the fetched data 402 is a header for an instruction block) that the processor core 102(0) still has available execution resources. The processor core 102(2) thus concludes that, regardless of which of the processor cores 102(0)-102(2) retrieves the next batch of fetched data, that fetched data should be sent to the processor core 102(0) for execution. Based on this conclusion, the processor core 102(2) stores an identifier of the processor core 102(0) as the execution processor core 102(0) in the PFE 206(0). The processor core 102(2) sends an instruction window tracker (“IWT 2”) 404 to the processor core 102(1) (which is responsible for predicting the next program identifier 310 following the program identifier 302, as seen in FIG. 3).

From this point onwards, the promote wave proceeds at the rate that fetched data becomes available to whichever of the processor cores 102(0)-102(2) that the promote wave currently reaches. In the example of FIG. 4, the promote wave has reached the processor core 102(1). Upon receiving the instruction window tracker 404, which indicates the processor core 102(0)-102(2) to which the data fetched for the program identifier 306 received by the processor core 102(1) from the processor core 102(2) should be sent, the processor core 102(1) initiates a fetch of fetched data (“FD 2”) 406 corresponding to the program identifier 306. When the fetched data 406 is received by the processor core 102(1), the processor core 102(1) sends the fetched data 406 to the processor core 102(0), as indicated by the instruction window tracker 404. Based on the size of the fetched data 406 or a size indicated by the fetched data 406, the processor core 102(1) also determines the processor core 102(0)-102(2) to which the next batch of fetched data corresponding to the program identifier 310 predicted by the processor core 102(1) in FIG. 3 should be sent. The processor core 102(1) thus generates an instruction window tracker (“IWT 3”) 408, and sends it to the processor core 102(0), which is responsible for predicting the next program identifier following the program identifier 310.

FIG. 4 also illustrates the detection and handling of a branch misprediction. In FIG. 4, assume that the predicted program identifier 306 generated by the processor core 102(2) turns out to be incorrect. This is detected by the processor core 102(0), which executed the instruction or instruction blocks corresponding to the preceding program identifier 302. To inform the processor core 102(2) that the prediction was incorrect, the processor core 102(0) identifies an active instruction window tracker 218(0) associated with the mispredicted program identifier 306, and uses the misprediction correction data 212′ stored in the active instruction window trackers 218(0)-218(Z) to correct the branch predictor resources 220 of the branch predictor 112(2) of the processor core 102(2).

The processor core 102(0) also determines a corrected program identifier (“C PRG ID”) 410, and identifies a processor core (in this example, the processor core 102(1)) of the plurality of processor cores 102(0)-102(X) as an execution processor core 102(1) for the corrected program identifier 410. The processor core 102(0) sends the global history indicator 210′ from the active instruction window tracker 218(0) and the corrected program identifier 410 to the processor core 102(1), where the predict-and-fetch wave will be restarted.

The processor core 102(0) then transmits a flush signal 412 to the processor cores 102(1), 102(2) to locate and terminate the current predict-and-fetch wave. Upon receiving the flush signal 412, the processor cores 102(1) and 102(2) flush any active instruction window trackers 218(0)-218(Z) that store fetched data younger than an age indicator 414 provided by the flush signal 412. In some aspects, there may be multiple flush signals 412 simultaneously active, and thus the processor cores 102(0)-102(2) may provide some form of arbitration to identify the oldest data to flush.

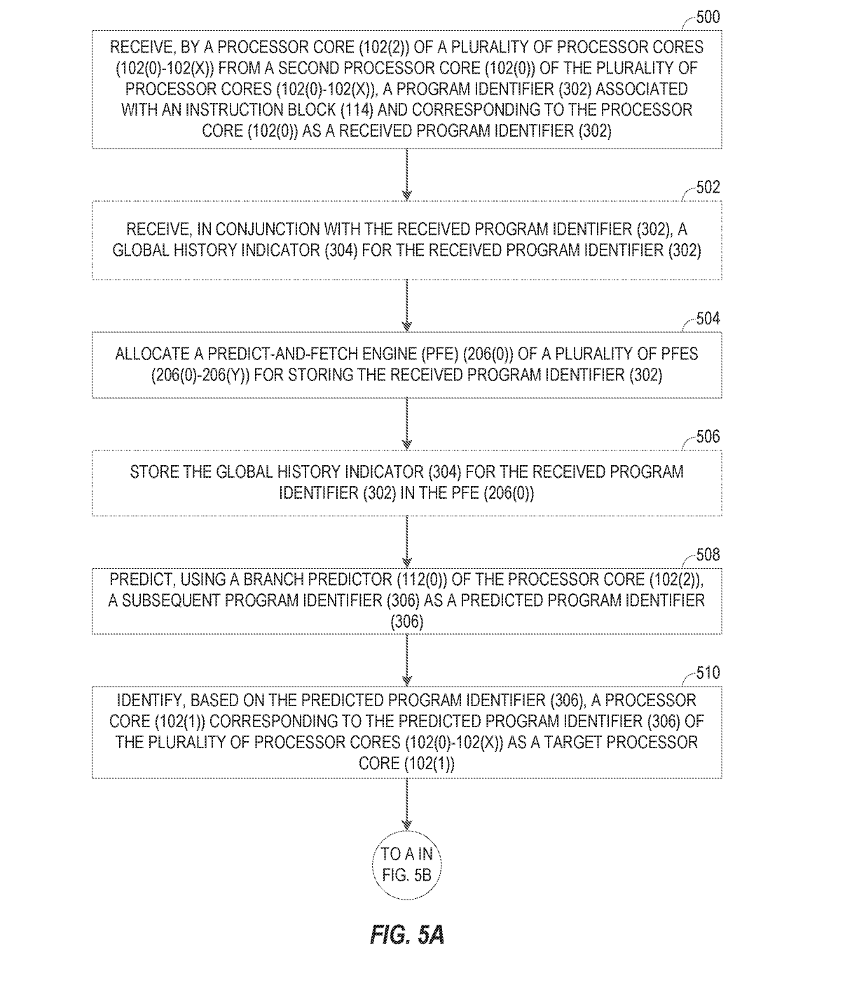

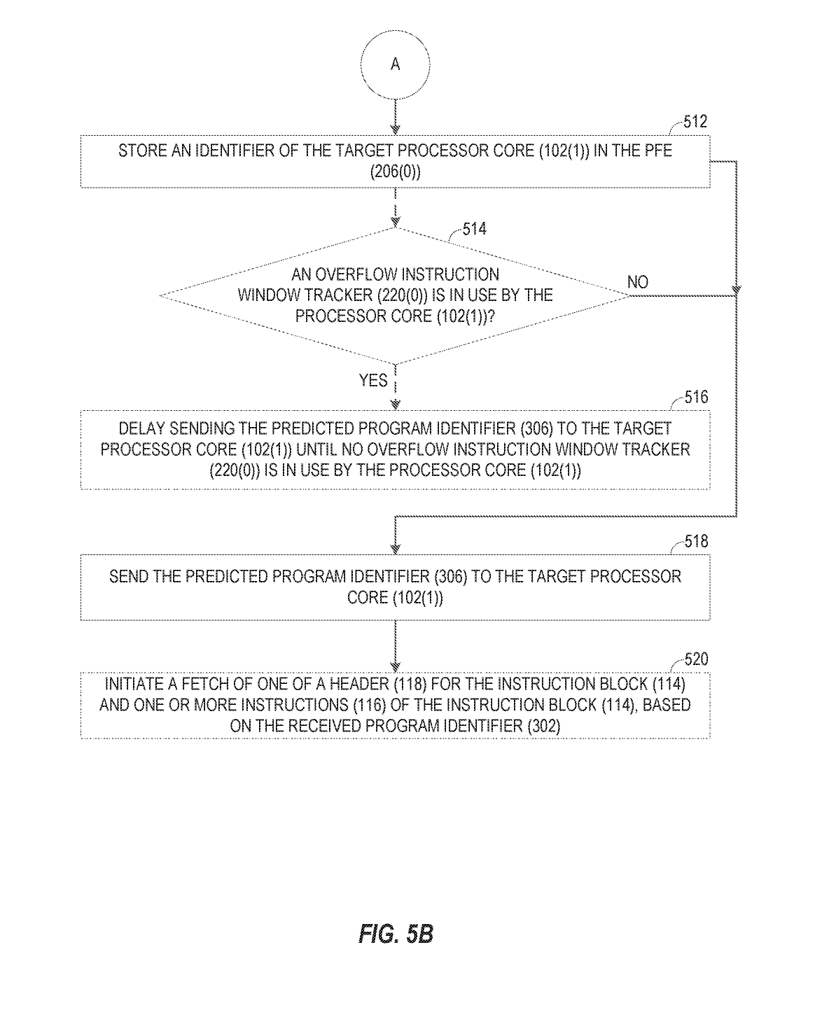

To illustrate exemplary operations of a processor core (e.g., the processor core 102(2)) of the multiple processor cores 102(0)-102(X) of FIGS. 1 and 2 for propagating a predict-and-fetch wave, FIGS. 5A and 5B are provided. For the sake of clarity, elements of FIGS. 1-3 are referenced in describing FIGS. 5A and 5B. In FIG. 5A, operations begin with the processor core 102(2) of the plurality of processor cores 102(0)-102(X) receiving, from a second processor core 102(0) of the plurality of processor cores 102(0)-102(X), a program identifier 302 associated with an instruction block 114 and corresponding to the processor core 102(0) as a received program identifier 302 (block 500). In this regard, the processor core 102(2) may be referred to herein as “a means for receiving, by a processor core of a plurality of processor cores, from a second processor core of the plurality of processor cores, a program identifier associated with an instruction block and corresponding to the processor core as a received program identifier.” In some aspects, the processor core 102(2) may also receive, in conjunction with the received program identifier 302, a global history indicator 304 for the received program identifier 302 (block 502).

The processor core 102(2) then allocates a PFE 206(0) of a plurality of PFEs 206(0)-206(Y) for storing the received program identifier 302 (block 504). Accordingly, the processor core 102(2) may be referred to herein as “a means for allocating a PFE of a plurality of PFEs for storing the received program identifier.” Some aspects may provide that the processor core 102(2) also stores the global history indicator 304 for the received program identifier 302 in the PFE 206(0) (block 506). The processor core 102(2) next predicts, using a branch predictor 112(0) of the processor core 102(2), a subsequent program identifier 306 as a predicted program identifier 306 (block 508). The processor core 102(2) thus may be referred to herein as “a means for predicting, using a branch predictor of the processor core, a subsequent program identifier as a predicted program identifier.”

The processor core 102(2) identifies, based on the predicted program identifier 306, a processor core 102(1) corresponding to the predicted program identifier 306 of the plurality of processor cores 102(0)-102(X) as a target processor core 102(1) (block 510). In this regard, the processor core 102(2) may be referred to herein as “a means for identifying, based on the predicted program identifier, a processor core of the plurality of processor cores corresponding to the predicted program identifier as a target processor core.” Processing then resumes at block 512 of FIG. 5B.

Referring now to FIG. 5B, the processor core 102(2) stores an identifier of the target processor core 102(1) in the PFE 206(0) (block 512). Accordingly, the processor core 102(2) may be referred to herein as “a means for storing an identifier of the target processor core in the PFE.” According to some aspects, the processor core 102(2) may determine whether an overflow instruction window tracker (such as the overflow instruction window tracker 220(0)) is in use by the processor core 102(1) (block 514). If so, the processor core 102(2) may delay sending the predicted program identifier 306 to the target processor core 102(1) until no overflow instruction window tracker 220(0) is in use by the processor core 102(1) (block 516). If the processor core 102(2) determines at decision block 514 that no overflow instruction window tracker 220(0) is in use by the processor core 102(1) (or if the processor core 102(1) does not employ an overflow instruction window tracker 220(0)), the processor core 102(2) sends the predicted program identifier 306 to the target processor core 102(1) (block 518). The processor core 102(2) thus may be referred to herein as “a means for sending the predicted program identifier to the target processor core.” The processor core 102(2) then initiates a fetch of one of a header 118 for the instruction block 114 and one or more instructions 116 of the instruction block 114, based on the received program identifier 302 (block 520). In this regard, the processor core 102(2) may be referred to herein as “a means for initiating a fetch of one of a header for the instruction block and one or more instructions of the instruction block based on the received program identifier.”

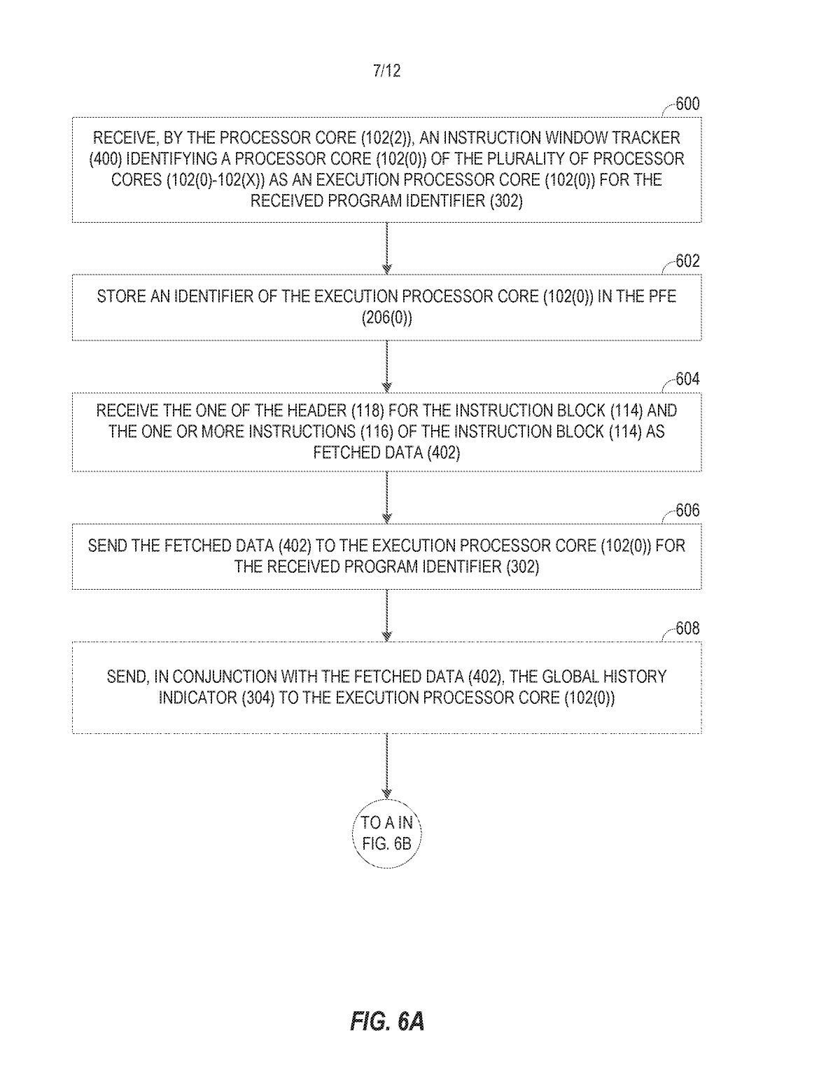

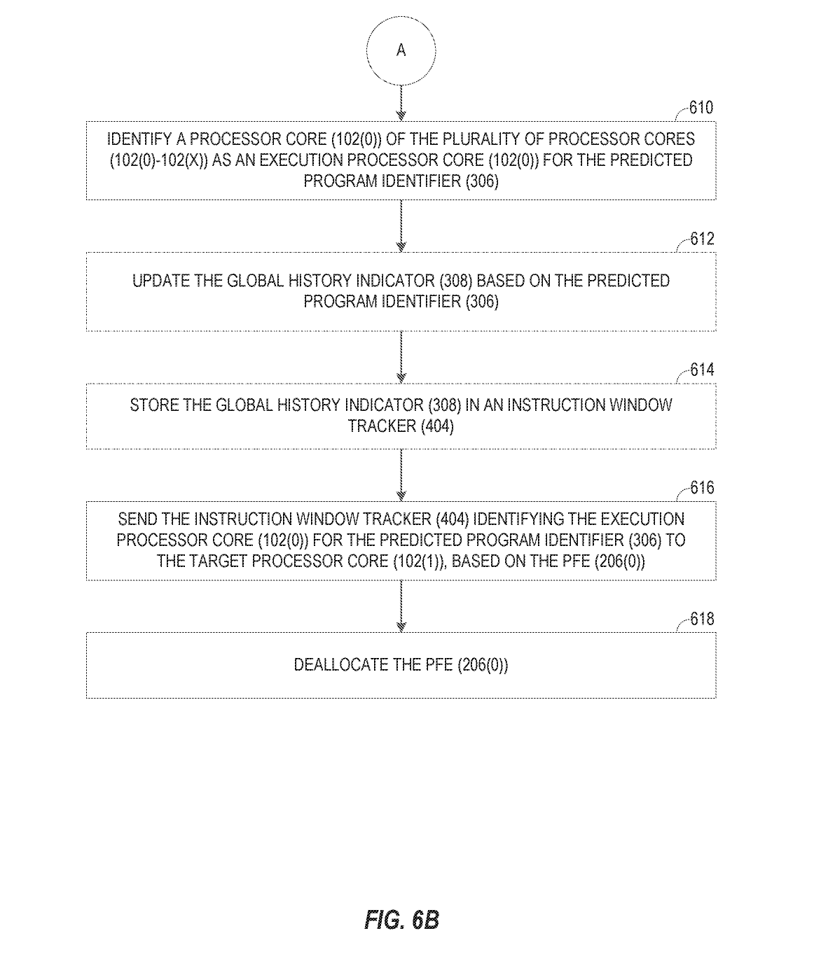

FIGS. 6A and 6B are provided to illustrate exemplary operations of a processor core 102(2) of the multiple processor cores 102(0)-102(X) of FIGS. 1 and 2 for propagating a promote wave. Elements of FIGS. 1-4 are referenced in describing FIGS. 6A and 6B for the sake of clarity. Operations in FIG. 6A begin with the processor core 102(2) receiving an instruction window tracker 400 identifying a processor core 102(0) of the plurality of processor cores 102(0)-102(X) as an execution processor core 102(0) for the received program identifier 302 (block 600). Accordingly, the processor core 102(2) may be referred to herein as “a means for receiving, by the processor core, an instruction window tracker identifying a processor core of the plurality of processor cores as an execution processor core for the received program identifier.” The processor core 102(2) stores an identifier of the execution processor core 102(0) in the PFE 206(0) (block 602). The processor core 102(2) thus may be referred to herein as “a means for storing an identifier of the execution processor core in the PFE.”

The processor core 102(2) then receives the one of the header 118 for the instruction block 114 and the one or more instructions 116 of the instruction block 114 as fetched data 402 (block 604). In this regard, the processor core 102(2) may be referred to herein as “a means for receiving the one of the header for the instruction block and the one or more instructions of the instruction block as fetched data.” The processor core 102(2) sends the fetched data 402 to the execution processor core 102(0) for the received program identifier 302 (block 606). Accordingly, the processor core 102(2) may be referred to herein as “a means for sending the fetched data to the execution processor core for the received program identifier.” In some aspects, the processor core 102(2) may also send, in conjunction with the fetched data 402, the global history indicator 304 to the execution processor core 102(0) (block 608). Processing then resumes at block 610 of FIG. 6B.

Turning to FIG. 6B, the processor core 102(2) next identifies a processor core 102(0) of the plurality of processor cores 102(0)-102(X) as an execution processor core 102(0) for the predicted program identifier 306 (block 610). The processor core 102(2) thus may be referred to herein as “a means for identifying a processor core of the plurality of processor cores as an execution processor core for the predicted program identifier.” Some aspects may provide that the processor core 102(2) also updates the global history indicator 308 based on the predicted program identifier 306 (block 612). The processor core 102(2) may then store the global history indicator 308 in an instruction window tracker 404 (block 614).

The processor core 102(2) then sends the instruction window tracker 404 identifying the execution processor core 102(0) for the predicted program identifier 306 to the target processor core 102(1), based on the PFE 206(0) (block 616). In this regard, the processor core 102(2) may be referred to herein as “a means for sending an instruction window tracker identifying the execution processor core for the predicted program identifier to the target processor core, based on the PFE.” The processor core 102(2) deallocates the PFE 206(0) (block 618). Accordingly, the processor core 102(2) may be referred to herein as “a means for deallocating the PFE.”

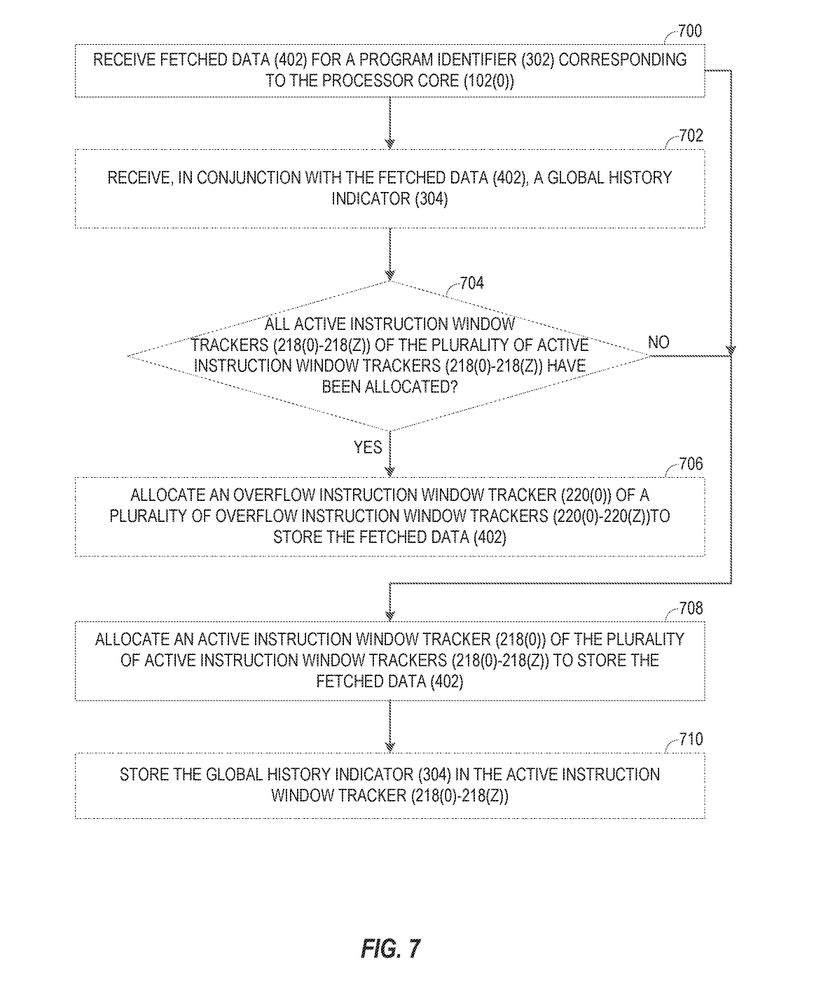

To illustrate exemplary operations of the processor core 102(0) of the multiple processor cores 102(0)-102(X) of FIGS. 1 and 2 for receiving and storing fetched data for execution, FIG. 7 is provided. For the sake of clarity, elements of FIGS. 1-4 are referenced in describing FIG. 7. In FIG. 7, operations begin with the processor core 102(0) receiving fetched data 402 for a program identifier 302 corresponding to the processor core 102(0) (block 700). According to some aspects, the processor core 102(0) may also receive, in conjunction with the fetched data 402, a global history indicator 304 (block 702). Some aspects of the processor core 102(0) may next determine whether all active instruction window trackers 218(0)-218(Z) of the plurality of active instruction window trackers 218(0)-218(Z) have been allocated (block 704). If so, the processor core 102(0) allocates an overflow instruction window tracker 220(0) of a plurality of overflow instruction window trackers 220(0)-220(Z) to store the fetched data 402 (block 706). If the processor core 102(0) determines at decision block 704 that not all of the active instruction window trackers 218(0)-218(Z) have been allocated (or if the processor core 102(0) does not employ the overflow instruction window trackers 220(0)-220(Z)), the processor core 102(0) allocates an active instruction window tracker 218(0) of the plurality of active instruction window trackers 218(0)-218(Z) to store the fetched data 402 (block 708). In some aspects, the processor core 102(0) may also store the global history indicator 304 in the active instruction window tracker 218(0)-218(Z) (block 710).

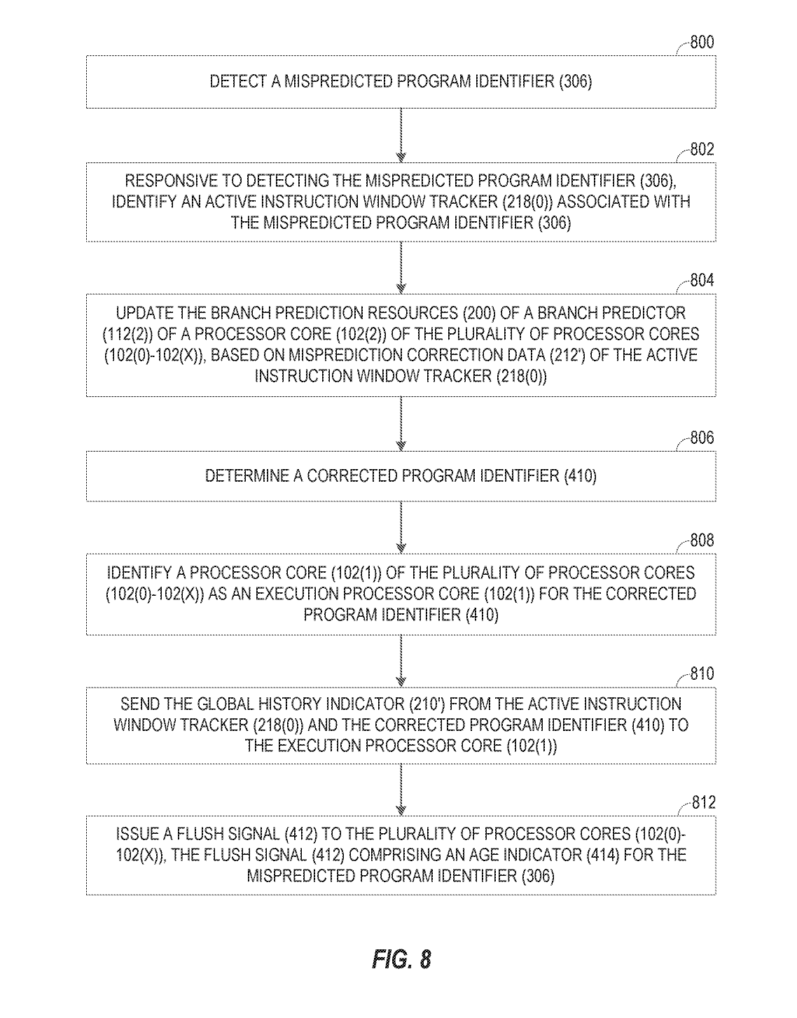

FIG. 8 illustrates exemplary operations of the processor core 102(0) of the multiple processor cores 102(0)-102(X) of FIGS. 1 and 2 for detecting and handling a branch misprediction. Elements of FIGS. 1-4 are referenced in describing FIG. 8 for the sake of clarity. Operations in FIG. 8 begin with the processor core 102(0) detecting a mispredicted program identifier 306 (block 800). In response, the processor core 102(0) identifies an active instruction window tracker 218(0) associated with the mispredicted program identifier 306 (block 802). The processor core 102(0) updates the branch prediction resources 200 of a branch predictor 112(2) of a processor core 102(2) of the plurality of processor cores 102(0)-102(X), based on the misprediction correction data 212 of the active instruction window tracker 218(0) (block 804).

The processor core 102(0) next determines a corrected program identifier 410 (block 806). The processor core 102(0) identifies a processor core 102(1) of the plurality of processor cores 102(0)-102(X) as an execution processor core 102(1) for the corrected program identifier 410 (block 808). The global history indicator 210′ from the active instruction window tracker 218(0) and the corrected program identifier 410 are sent by the processor core 102(1) to the execution processor core 102(0) (block 810). The processor core 102(0) then issues a flush signal 412 to the plurality of processor cores 102(0)-102(X), the flush signal 412 comprising an age indicator 414 for the mispredicted program identifier 306 (block 812).

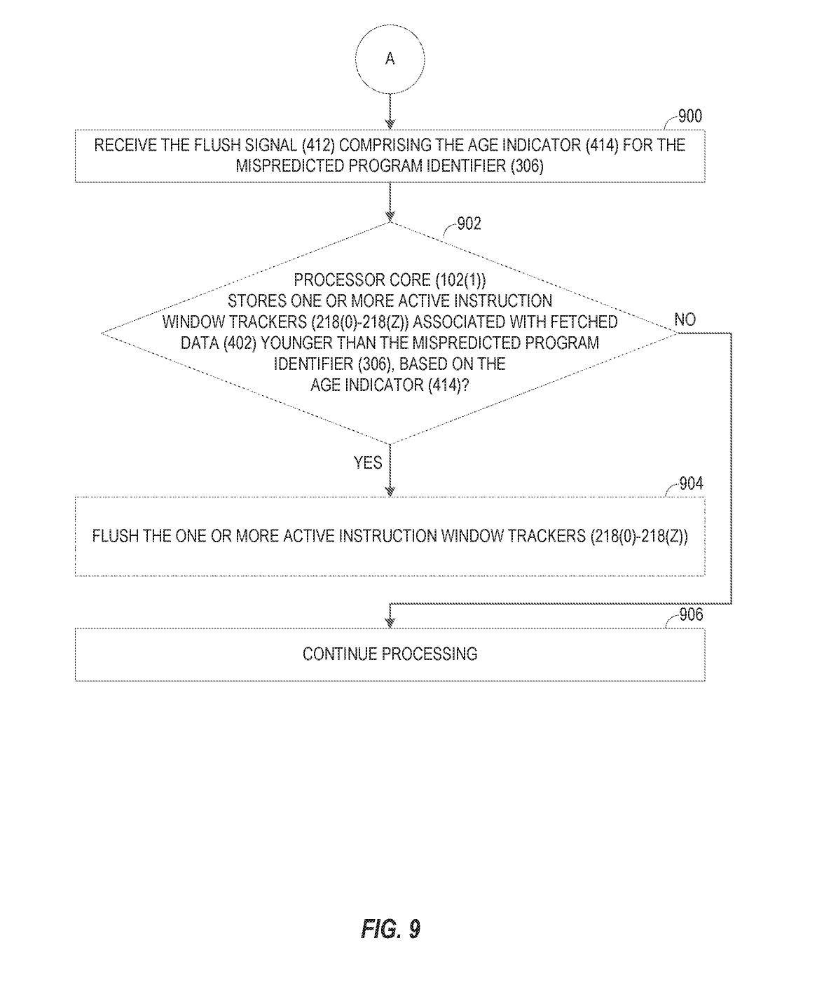

To illustrate exemplary operations of the processor core 102(1) of the multiple processor cores 102(0)-102(X) of FIGS. 1 and 2 for receiving and handling the flush signal 412, FIG. 9 is provided. For the sake of clarity, elements of FIGS. 1-4 are referenced in describing FIG. 9. In FIG. 9, the processor core 102(1) receives the flush signal 412 comprising the age indicator 414 for the mispredicted program identifier 306 (block 900). The processor core 102(1) then determines whether the processor core 102(1) stores one or more active instruction window trackers 218(0)-218(Z) associated with fetched data 402 younger than the mispredicted program identifier 306, based on the age indicator 414 (block 902). If so, the processor core 102(1) flushes the one or more active instruction window trackers 218(0)-218(Z) (block 904). Otherwise, the processor core 102(1) continues processing (block 906). It is to be understood that these operations for receiving and handling the flush signal 412 are carried out not only by the processor core 102(1), but all of the processor cores 102(0)-102(X) receiving the flush signal 412.

Performing distributed branch prediction using fused processor cores in processor-based systems according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

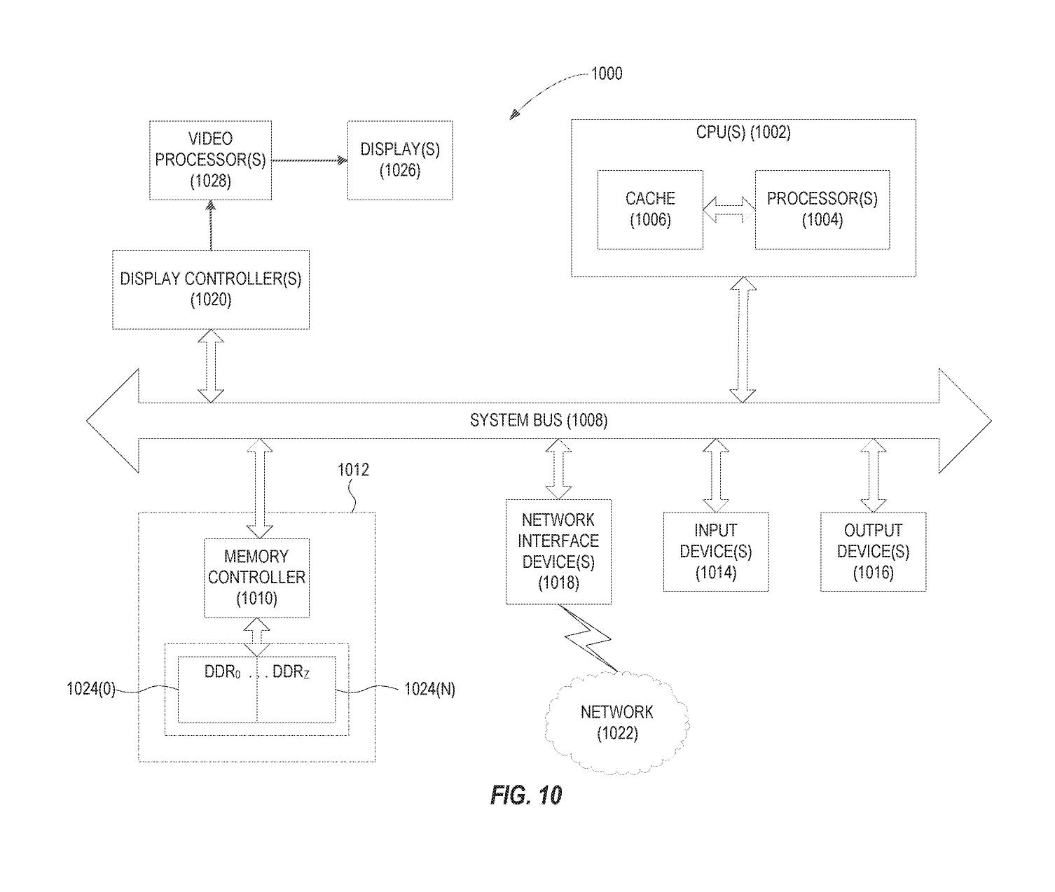

In this regard, FIG. 10 illustrates an example of a processor-based system 1000 that may correspond to the processor-based system 100 of FIG. 1, and that include the processor cores 102(0)-102(X) illustrated in FIGS. 1 and 2. In this example, the processor-based system 1000 includes one or more central processing units (CPUs) 1002, each including one or more processors 1004. The one or more processors 1004 in some aspects may correspond to the processor cores 102(0)-102(X) of FIGS. 1 and 2. The CPU(s) 1002 may be a master device. The CPU(s) 1002 may have cache memory 1006 coupled to the processor(s) 1004 for rapid access to temporarily stored data. The CPU(s) 1002 is coupled to a system bus 1008 and can intercouple master and slave devices included in the processor-based system 1000. As is well known, the CPU(s) 1002 communicates with these other devices by exchanging address, control, and data information over the system bus 1008. For example, the CPU(s) 1002 can communicate bus transaction requests to a memory controller 1010 as an example of a slave device.

Other master and slave devices can be connected to the system bus 1008. As illustrated in FIG. 10, these devices can include a memory system 1012, one or more input devices 1014, one or more output devices 1016, one or more network interface devices 1018, and one or more display controllers 1020, as examples. The input device(s) 1014 can include any type of input device, including but not limited to input keys, switches, voice processors, etc. The output device(s) 1016 can include any type of output device, including but not limited to audio, video, other visual indicators, etc. The network interface device(s) 1018 can be any devices configured to allow exchange of data to and from a network 1022. The network 1022 can be any type of network, including but not limited to a wired or wireless network, a private or public network, a local area network (LAN), a wide local area network (WLAN), and the Internet. The network interface device(s) 1018 can be configured to support any type of communications protocol desired. The memory system 1012 can include one or more memory units 1024(0)-1024(N).

The CPU(s) 1002 may also be configured to access the display controller(s) 1020 over the system bus 1008 to control information sent to one or more displays 1026. The display controller(s) 1020 sends information to the display(s) 1026 to be displayed via one or more video processors 1028, which process the information to be displayed into a format suitable for the display(s) 1026. The display(s) 1026 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, Dynamic RAM (DRAM), Synchronous DRAM (SDRAM), a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sets other than the illustrated sets. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A distributed branch predictor for a multi-core processor-based system, comprising:
a plurality of processor cores configured to interoperate as a fused processor core, and each comprising:
a branch predictor; and
a plurality of predict-and-fetch engines (PFEs); and
each processor core of the plurality of processor cores configured to:
receive, from a second processor core of the plurality of processor cores, a program identifier associated with an instruction block and corresponding to the processor core as a received program identifier;
allocate a PFE of the plurality of PFEs for storing the received program identifier;
predict, using the branch predictor, a subsequent program identifier as a predicted program identifier;
identify, based on the predicted program identifier, a processor core of the plurality of processor cores corresponding to the predicted program identifier as a target processor core;
store an identifier of the target processor core in the PFE;
send the predicted program identifier to the target processor core; and
initiate a fetch of one of a header for the instruction block and one or more instructions of the instruction block based on the received program identifier.

2. The distributed branch predictor of claim 1, wherein each processor core of the plurality of processor cores is further configured to:
receive an instruction window tracker identifying a processor core of the plurality of processor cores as an execution processor core for the received program identifier;
store an identifier of the execution processor core in the PFE;
receive the one of the header for the instruction block and the one or more instructions of the instruction block as fetched data;
send the fetched data to the execution processor core for the received program identifier;
identify a processor core of the plurality of processor cores as an execution processor core for the predicted program identifier;
send an instruction window tracker identifying the execution processor core for the predicted program identifier to the target processor core, based on the PFE; and
deallocate the PFE.

3. The distributed branch predictor of claim 2, wherein each processor core of the plurality of processor cores is configured to identify the processor core of the plurality of processor cores as the execution processor core for the predicted program identifier based on a number of instructions between the received program identifier and the predicted program identifier.

4. The distributed branch predictor of claim 2, wherein each processor core of the plurality of processor cores is further configured to:
receive, in conjunction with the received program identifier, a global history indicator for the received program identifier;
store the global history indicator for the received program identifier in the PFE;
send, in conjunction with the fetched data, the global history indicator to the execution processor core for the received program identifier;
update the global history indicator based on the predicted program identifier; and
prior to sending the instruction window tracker for the predicted program identifier, store the global history indicator in the instruction window tracker for the predicted program identifier.

5. The distributed branch predictor of claim 2, wherein:
each processor core of the plurality of processor cores further comprises a plurality of active instruction window trackers; and
each processor core of the plurality of processor cores is further configured to:
receive fetched data for a program identifier corresponding to the processor core; and
allocate an active instruction window tracker of the plurality of active instruction window trackers to store the fetched data.

6. The distributed branch predictor of claim 5, wherein:
each processor core of the plurality of processor cores further comprises a plurality of overflow instruction window trackers;
each processor core of the plurality of processor cores is further configured to, prior to allocating the active instruction window tracker:
determine whether all active instruction window trackers of the plurality of active instruction window trackers have been allocated; and
responsive to determining that all active instruction window trackers of the plurality of active instruction window trackers have been allocated, allocate an overflow instruction window tracker of the plurality of overflow instruction window trackers to store the fetched data; and
each processor core of the plurality of processor cores is configured to allocate the active instruction window tracker of the plurality of active instruction window trackers to store the fetched data responsive to determining that not all active instruction window trackers of the plurality of active instruction window trackers have been allocated.

7. The distributed branch predictor of claim 6, wherein:
each processor core of the plurality of processor cores is further configured to, prior to sending the predicted program identifier to the target processor core:
determine whether an overflow instruction window tracker is in use by the target processor core; and
responsive to determining that an overflow instruction window tracker is in use by the target processor core, delay sending the predicted program identifier to the target processor core until no overflow instruction window tracker is in use by the target processor core; and
each processor core of the plurality of processor cores is configured to send the predicted program identifier to the target processor core responsive to determining that no overflow instruction window tracker is in use by the target processor core.

8. The distributed branch predictor of claim 5, wherein each processor core of the plurality of processor cores is further configured to:
receive, in conjunction with the fetched data, a global history indicator; and
store the global history indicator in the active instruction window tracker.

9. The distributed branch predictor of claim 8, wherein each processor core of the plurality of processor cores is further configured to:
detect a mispredicted program identifier;
responsive to detecting the mispredicted program identifier, identify an active instruction window tracker associated with the mispredicted program identifier;
update branch prediction resources of a branch predictor of a processor core of the plurality of processor cores, based on misprediction correction data of the active instruction window tracker;
determine a corrected program identifier;
identify a processor core of the plurality of processor cores as an execution processor core for the corrected program identifier;
send the global history indicator from the active instruction window tracker and the corrected program identifier to the execution processor core; and
issue a flush signal to the plurality of processor cores, the flush signal comprising an age indicator for the mispredicted program identifier.

10. The distributed branch predictor of claim 9, wherein each processor core of the plurality of processor cores is further configured to:
receive the flush signal comprising the age indicator for the mispredicted program identifier;
determine whether the processor core stores one or more active instruction window trackers associated with fetched data younger than the mispredicted program identifier, based on the age indicator; and
responsive to determining that the processor core stores one or more active instruction window trackers associated with fetched data younger than the mispredicted program identifier, flush the one or more active instruction window trackers.

11. The distributed branch predictor of claim 1, wherein:
each processor core of the plurality of processor cores further comprises an address interleaved instruction cache; and
each processor core of the plurality of processor cores is configured to initiate the fetch of the one of the header for the instruction block and the one or more instructions of the instruction by accessing the address interleaved instruction cache.

12. The distributed branch predictor of claim 1, wherein:
each processor core of the plurality of processor cores is further configured to, prior to allocating the PFE of the plurality of PFEs for storing the received program identifier:
determine whether a PFE, of the plurality of PFEs is available; and
responsive to determining that no PFE, of the plurality of PFEs is available, delay sending the predicted program identifier to the target processor core until a PFE of the plurality of PFEs becomes available; and
each processor core of the plurality of processor cores is configured to allocate the PFE of the plurality of PFEs for storing the received program identifier responsive to determining that a PFE of the plurality of PFEs is available.

13. The distributed branch predictor of claim 1 integrated into an integrated circuit (IC).

14. The distributed branch predictor of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device (e.g., a smart watch, a health or fitness tracker, eyewear, etc.); a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

15. A distributed branch predictor, comprising:
a means for receiving, by a processor core of a plurality of processor cores, from a second processor core of the plurality of processor cores, a program identifier associated with an instruction block and corresponding to the processor core as a received program identifier;
a means for allocating a predict-and-fetch engine (PFE) of a plurality of PFEs for storing the received program identifier;
a means for predicting, using a branch predictor of the processor core, a subsequent program identifier as a predicted program identifier;
a means for identifying, based on the predicted program identifier, a processor core of the plurality of processor cores corresponding to the predicted program identifier as a target processor core;
a means for storing an identifier of the target processor core in the PFE;
a means for sending the predicted program identifier to the target processor core; and
a means for initiating a fetch of one of a header for the instruction block and one or more instructions of the instruction block based on the received program identifier.

16. The distributed branch predictor of claim 15, further comprising:
a means for receiving, by the processor core, an instruction window tracker identifying a processor core of the plurality of processor cores as an execution processor core for the received program identifier;
a means for storing an identifier of the execution processor core in the PFE;
a means for receiving the one of the header for the instruction block and the one or more instructions of the instruction block as fetched data;
a means for sending the fetched data to the execution processor core for the received program identifier;
a means for identifying a processor core of the plurality of processor cores as an execution processor core for the predicted program identifier;
a means for sending an instruction window tracker identifying the execution processor core for the predicted program identifier to the target processor core, based on the PFE; and
a means for deallocating the PFE.

17. A method for performing distributed branch prediction, comprising:
receiving, by a processor core of a plurality of processor cores, from a second processor core of the plurality of processor cores, a program identifier associated with an instruction block and corresponding to the processor core as a received program identifier;
allocating a predict-and-fetch engine (PFE) of a plurality of PFEs for storing the received program identifier;
predicting, using a branch predictor of the processor core, a subsequent program identifier as a predicted program identifier;
identifying, based on the predicted program identifier, a processor core of the plurality of processor cores corresponding to the predicted program identifier as a target processor core;
storing an identifier of the target processor core in the PFE;
sending the predicted program identifier to the target processor core; and
initiating a fetch of one of a header for the instruction block and one or more instructions of the instruction block based on the received program identifier.

18. The method of claim 17, further comprising:
receiving, by the processor core, an instruction window tracker identifying a processor core of the plurality of processor cores as an execution processor core for the received program identifier;
storing an identifier of the execution processor core in the PFE;
receiving the one of the header for the instruction block and the one or more instructions of the instruction block as fetched data;
sending the fetched data to the execution processor core for the received program identifier;
identifying a processor core of the plurality of processor cores as an execution processor core for the predicted program identifier;
sending an instruction window tracker identifying the execution processor core for the predicted program identifier to the target processor core, based on the PFE; and
deallocating the PFE.

19. The method of claim 18, wherein identifying the processor core of the plurality of processor cores as the execution processor core for the predicted program identifier is based on a number of instructions between the received program identifier and the predicted program identifier.

20. The method of claim 18, further comprising:
receiving, in conjunction with the received program identifier, a global history indicator for the received program identifier;
storing the global history indicator for the received program identifier in the PFE;
sending, in conjunction with the fetched data, the global history indicator to the execution processor core for the received program identifier;
updating the global history indicator based on the predicted program identifier; and
prior to sending the instruction window tracker for the predicted program identifier, storing the global history indicator in the instruction window tracker for the predicted program identifier.

21. The method of claim 18, further comprising:
receiving fetched data for a program identifier corresponding to the processor core; and
allocating an active instruction window tracker of a plurality of active instruction window trackers to store the fetched data.

22. The method of claim 21, further comprising, prior to allocating the active instruction window tracker:
determining whether all active instruction window trackers of the plurality of active instruction window trackers have been allocated; and
responsive to determining that all active instruction window trackers of the plurality of active instruction window trackers have been allocated, allocate an overflow instruction window tracker of a plurality of overflow instruction window trackers to store the fetched data;
wherein allocating the active instruction window tracker of the plurality of active instruction window trackers to store the fetched data is responsive to determining that not all active instruction window trackers of the plurality of active instruction window trackers have been allocated.

23. The method of claim 22, further comprising, prior to sending the predicted program identifier to the target processor core:
determining whether an overflow instruction window tracker is in use by the processor core; and
responsive to determining that an overflow instruction window tracker is in use by the processor core, delaying sending the predicted program identifier to the target processor core until no overflow instruction window tracker is in use by the processor core;
wherein sending the predicted program identifier to the target processor core is responsive to determining that no overflow instruction window tracker is in use by the processor core.

24. The method of claim 21, further comprising:
receiving, in conjunction with the fetched data, a global history indicator; and
storing the global history indicator in the active instruction window tracker.

25. The method of claim 24, further comprising:
detecting a mispredicted program identifier;
responsive to detecting the mispredicted program identifier, identifying an active instruction window tracker associated with the mispredicted program identifier;
updating branch prediction resources of a branch predictor of a processor core of the plurality of processor cores, based on misprediction correction data of the active instruction window tracker;
determining a corrected program identifier;
identifying a processor core of the plurality of processor cores as an execution processor core for the corrected program identifier;
sending the global history indicator from the active instruction window tracker and the corrected program identifier to the execution processor core; and
issuing a flush signal to the plurality of processor cores, the flush signal comprising an age indicator for the mispredicted program identifier.

26. The method of claim 25, further comprising:
receiving the flush signal comprising the age indicator for the mispredicted program identifier;
determining whether the processor core stores one or more active instruction window trackers associated with fetched data younger than the mispredicted program identifier, based on the age indicator; and
responsive to determining that the processor core stores one or more active instruction window trackers associated with fetched data younger than the mispredicted program identifier, flushing the one or more active instruction window trackers.

27. The method of claim 17, wherein initiating the fetch of the one of the header for the instruction block and the one or more instructions of the instruction block comprises accessing an address interleaved instruction cache of the processor core.

28. The method of claim 17, further comprising, prior to allocating the PFE of the plurality of PFEs for storing the received program identifier:
determining whether a PFE of the plurality of PFEs is available; and
responsive to determining that no PFE of the plurality of PFEs is available, delaying sending the predicted program identifier to the target processor core until a PFE of the plurality of PFEs becomes available;
wherein allocating the PFE of the plurality of PFEs for storing the received program identifier is responsive to determining that a PFE of the plurality of PFEs is available.
